(19) United States
(12) Patent Application Publication
(10) Pub. No.: US 2018/0160210 A1
(43) Pub. Date: Jun. 7, 2018

(54) UNIFIT SLEEVE FOR AN EARPIECE

(71) Applicant: BRAGI GmbH, Munchen (DE)

(72) Inventors: Christian Begusch, Munchen (DE); Martin Steiner, Munchen (DE)

(73) Assignee: BRAGI GmbH, Munchen (DE)

(21) Appl. No.: 15/822,836

(22) Filed: Nov. 27, 2017

Related U.S. Application Data
(60) Provisional application No. 62/430,265, filed on Dec. 5, 2016.

(51) Int. Cl. H04R 1/10; H04R 25/00

(52) U.S. Cl. CPC H04R 1/1016; H04R 2460/11; H04R 25/652; H04R 1/1091

(57) ABSTRACT

A unifit sleeve includes a base portion, a stem portion, and a conduit extending through the base portion and the stem portion. An outer flange faces outward and downward toward the base portion. A circumferential cavity occupies the space between the outer flange and the stem portion and a self-conforming member biases the outer flange away from the stem portion. A hydrophobic constituent may also be affixed to the inside of the outer flange and the outside of the stem portion to prevent ingressing moisture. The unifit sleeve may be fitted to a wireless earpiece or other wearable device.

### RELATED APPLICATION

This application claims priority to U.S. Provisional Application No. 62/430,265, filed Dec. 5, 2016, hereby incorporated by reference in its entirety.

### FIELD OF THE INVENTION

The present invention relates to a unifit sleeve. More particularly, but not exclusively, the present invention relates to a unifit sleeve for a wireless earpiece.

### BACKGROUND

Wireless earpieces have at least a portion generally formed and sized to fit the average dimensions of the human external auditory canal. Given that the external auditory canal can vary in size and shape, it becomes necessary to supply more than one sleeve size so the wireless earpiece can be custom fit to virtually any size and shape external auditory canal. Supplying wireless earpieces with a set of different size sleeves is both costly and wasteful given that the user will likely only select and use the size sleeve that best fits them; the non-fitting sleeves often go unused and are often discarded. Therefore, there is a need to provide a unifit sleeve configured to fit all sizes of earpieces so that unnecessary economic waste can be avoided.

### SUMMARY

Therefore, it is a primary object, feature, or advantage of the present invention to improve over the state of the art.

It is a further object, feature, or advantage of the present invention to provide a unifit sleeve that may fit any number of size and shape external auditory canals.

It is a still further object, feature, or advantage of the present invention to provide a unifit sleeve for a wireless earpiece.

Another object, feature, or advantage is to provide a unifit sleeve with a self-conforming member that can seal the external auditory canal notwithstanding their different size and shapes.

Yet another object, feature, or advantage is to provide a hydrophobic constituent which protects the self-conforming member from unwanted ingressing moisture.

In one embodiment, a unifit sleeve includes a base portion having an inner end, an outer circumference, an inner circumference, and a stem portion extending from the base portion and terminating at an outer end. The stem portion has an outer circumference and an inner circumference. A conduit extends through the base portion and the stem portion from the inner end of the base portion to the outer end of the stem portion. The inner circumference of the base portion and the inner circumference of the stem portion circumscribe the conduit. The conduit is further configured for operably securing to a wearable device. An outer flange connects to the outer end of the stem portion. The outer flange has an exterior surface and an interior surface and extends outwardly and downwardly toward the base portion. A circumferential cavity defines the space between the interior surface of the outer flange and the outer circumference of the stem portion. The self-conforming member is disposed within the circumferential cavity and is affixed within the circumferential cavity at the outer end of the stem portion, wherein the self-conforming member biases the outer flange outward away from the outer circumference of the stem portion.

One or more of the following features may be included. The self-conforming member may be composed of a memory foam. The self-conforming member may include a hydrophobic constituent affixed between the outer circumference of the stem portion and the interior surface of the outer flange at a bottom end of the self-conforming member. A hydrophobic constituent may be affixed to the interior surface of the outer flange and the outer circumference of the stem portion, wherein the hydrophobic constituent may enclose the circumferential cavity with the self-conforming member. A second circumferential cavity may be disposed between the self-conforming member and the hydrophobic constituent, wherein the second circumferential cavity may be filled in response to a compression of the self-conforming member. At least one second conduit may be disposed longitudinally within the outer flange and may be configured to pass through the outer flange to vent the external auditory canal to an outside of an ear.

In another embodiment, a self-conforming earpiece sleeve includes a base portion having an inner end, an outer circumference, an inner circumference, and a stem portion extending from the base portion and terminating at an outer end. The stem portion has an outer circumference and an inner circumference. A conduit extends through the base portion and the stem portion from the inner end of the base portion to the outer end of the stem portion. The inner circumference of the base portion and the inner circumference of the stem portion circumscribe the conduit having a connection interface operably configured for securing to a tip of a wireless earpiece. An outer flange is connected to the outer end of the stem portion. The outer flange has an exterior surface and an interior surface wherein the outer flange extends outwardly and downwardly from the outer end toward the base portion. A circumferential cavity resides between the interior surface of the outer flange and the outer circumference of the stem portion. A self-conforming member is disposed within the circumferential cavity. The self-conforming member is affixed within the circumferential cavity adjacent the outer end of the stem portion. A hydrophobic constituent is disposed in combination with the self-conforming member at the interior surface of the outer flange and the outer circumference of the stem portion, wherein the hydrophobic constituent substantially occludes moisture from interacting with the self-conforming member. The self-conforming member biases the outer flange outward away from the outer circumference of the stem portion.

One or more of the following features may be included. The self-conforming member may be composed of a memory foam. A second circumferential cavity may be disposed between the self-conforming member and the hydrophobic constituent, wherein the second circumferential cavity may be filled in response to a compression of the self-conforming member. The self-conforming member may be configured when inserted into an external auditory canal of an ear to bias the outer flange outward against the external auditory canal. The self-conforming member may bias the outer flange against the external auditory canal wherein points of contact between the outer flange and the external auditory canal may comprise a 360° circumference. At least one second conduit may be disposed longitudinally within the outer flange and may be configured to connect an external auditory canal to an outside of an ear.

In another embodiment, a unifit sleeve for a wireless earpiece includes a base portion having an inner end, an outer circumference and an inner circumference. A stem portion extends from the base portion and terminates at an outer end. The stem portion has an outer circumference and an inner circumference. A conduit extends through the base portion and the stem portion from the inner end of the base portion to the outer end of the stem portion, wherein the inner circumference of the base portion and the inner circumference of the stem portion circumscribe the conduit configured for operably securing to the wireless earpiece. An outer flange connects to the outer end of the stem portion. The outer flange has an exterior surface and an interior surface wherein the outer flange extends outwardly and downwardly toward the base portion. A circumferential cavity resides between the interior surface of the outer flange and the outer circumference of the stem portion. A self-conforming member is disposed within the circumferential cavity. The self-conforming member is affixed within the circumferential cavity at the outer end of the stem portion, wherein the self-conforming member biases the outer flange outward away from the outer circumference of the stem portion. The unifit sleeve is operably secured to a tip of the wireless earpiece, and the tip of the wireless earpiece with the unifit sleeve operably secured to the tip is configured to be operably placed into an external auditory canal of an ear.

One or more of the following features may be included. The self-conforming member may be composed of a memory foam. The self-conforming member may comprise an air pillow. A hydrophobic constituent may be affixed to the interior surface of the outer flange and the outer circumference of the stem portion, wherein the hydrophobic constituent may enclose the circumferential cavity within the self-conforming member. A second circumferential cavity may be disposed between the self-conforming member and the hydrophobic constituent, wherein the second circumferential cavity is filled in response to a compression of the self-conforming member. The self-conforming member may be configured when inserted into an external auditory canal of an ear to bias the outer flange outward against the external auditory canal. The self-conforming member may bias the outer flange against the external auditory canal wherein the points of contact between the outer flange and the external auditory canal may comprise a 360° circumference. At least one second conduit may be disposed longitudinally within the outer flange and may be configured to connect an external auditory canal to an outside of an ear.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an object, feature, or advantage stated herein.

### BRIEF DESCRIPTION OF THE DRAWINGS

FIG. 1 illustrates a perspective view of the unifit sleeve attached to a wireless earpiece.

FIG. 2 illustrates a perspective view of a wearable device with a unifit sleeve fitted into an external auditory canal.

FIG. 3 illustrates a sectional view of the unifit sleeve.

FIG. 4 illustrates a sectional view of a wearable device with a unifit sleeve fitted into an external auditory canal.

FIG. 5 illustrates a second embodiment of the wearable device with a unifit sleeve fitted into an external auditory canal.

### DETAILED DESCRIPTION

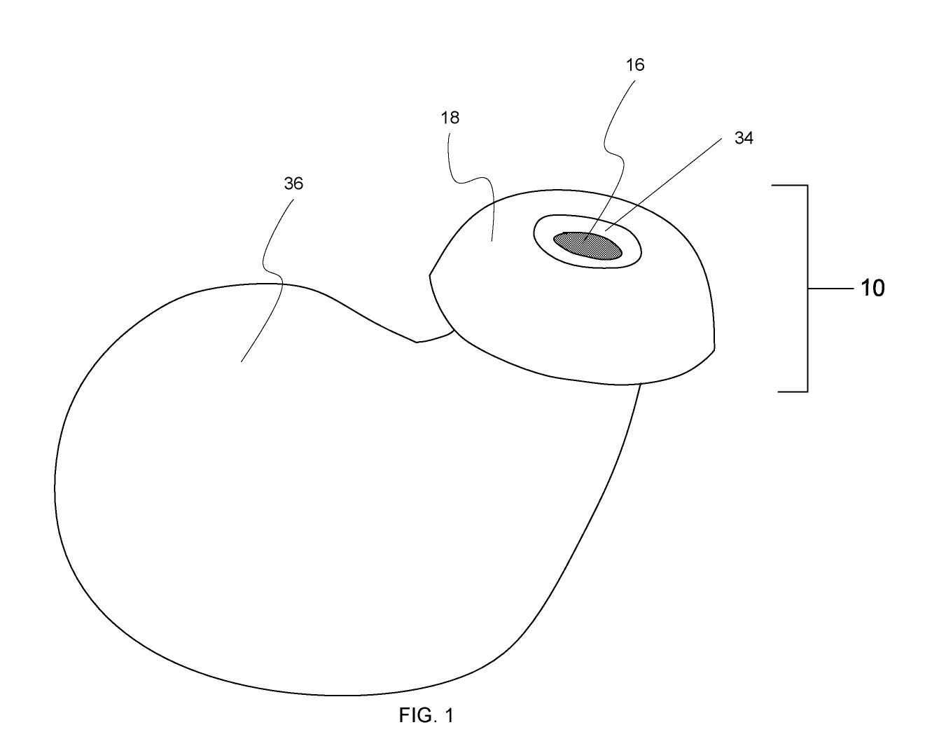

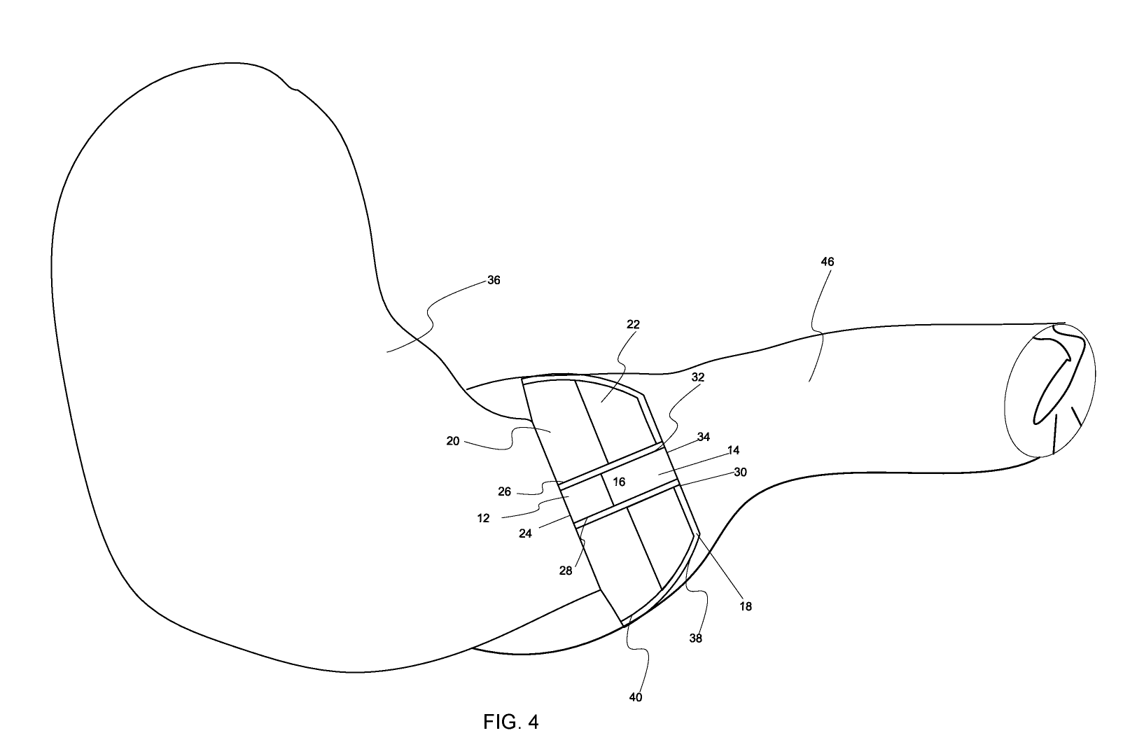

FIG. 1 illustrates a perspective view of the unifit sleeve 10 fitted onto a wireless earpiece 36. The unifit sleeve 10 includes an outer flange 18 that extends outward and downward from a stem portion and is biased outward by a self-conforming member (as best illustrated in FIG. 4). The unifit sleeve 10 may be fitted to a wireless earpiece 36 by elastically stretching a base portion (as best illustrated in FIG. 4) and some of the stem portion to allow a tip of the wireless earpiece to fit into a conduit 16 (see FIG. 4) defined by the interiors of the base portion and the stem portion. The tip of the wireless earpiece may partially or completely fill the conduit 16. The conduit 16 may be open at an outer end 34 to allow sound to be communicated via the wireless earpiece 36 through the tip.

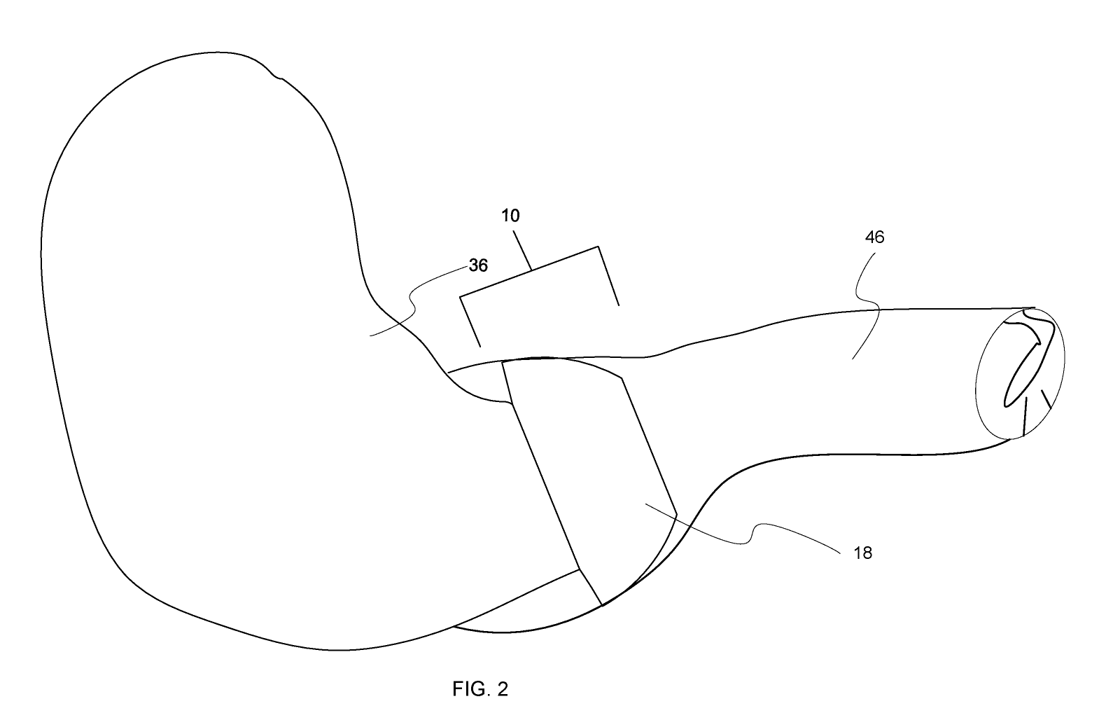

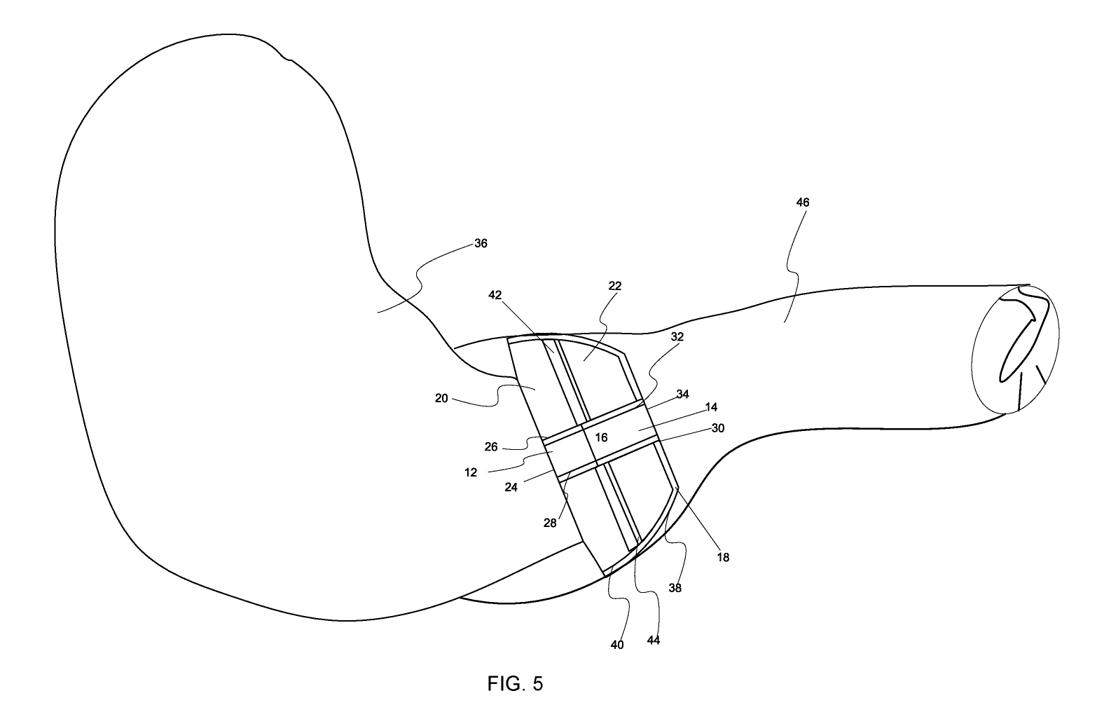

FIG. 2 illustrates a perspective view of a wireless earpiece 36 with the unifit sleeve 10 placed into an external auditory canal 46 of an ear. The wireless earpiece tip of the wireless earpiece 36 may be partially or completely inserted into the external auditory canal 46, and the proportion of the tip that is inserted into the external auditory canal 46 may depend on the physical characteristics of the user's ears. For example, if the user has a smaller than average external auditory canal, the wireless earpiece tip with the unifit sleeve may only partially fit into the user's external auditory canal. The unifit sleeve 10 may be attached to the wireless earpiece tip by elastically slipping the base portion 12 of the unifit sleeve 10 (See FIG. 4) onto the wireless earpiece tip, wherein the unifit sleeve 10 may be held to the wireless earpiece tip via compressive and/or adhesive forces. Part of the stem portion 14 (See FIG. 4) may be elastically retained on the wireless earpiece tip as well. A self-conforming member 22 (See FIG. 4) may bias the outer flange 18 against the internal wall of the external auditory canal 46 creating a snug fit upon insertion of the wireless earpiece tip with the unifit sleeve 10 into the external auditory canal 46. In some embodiments the self-conforming member 22 (See FIG. 4) may also partially or completely compress into a second circumferential cavity 44 (See FIG. 5) in response to being placed within the external auditory canal 46, allowing the unifit sleeve 10 to accommodate a wider range of size and shape differences of the external auditory canal. A hydrophobic constituent may also be impregnated into the material making up the self-conforming member 22. In another aspect, a hydrophobic constituent 42 (See FIG. 4) may be attached to the unifit sleeve 10 and may face outward from the external auditory canal 46 upon insertion of the wireless earpiece tip into the external auditory canal 46. The hydrophobic constituent 42 may repel sweat and moisture during use. In addition, the hydrophobic constituent 42 may repel water if the user is underwater.

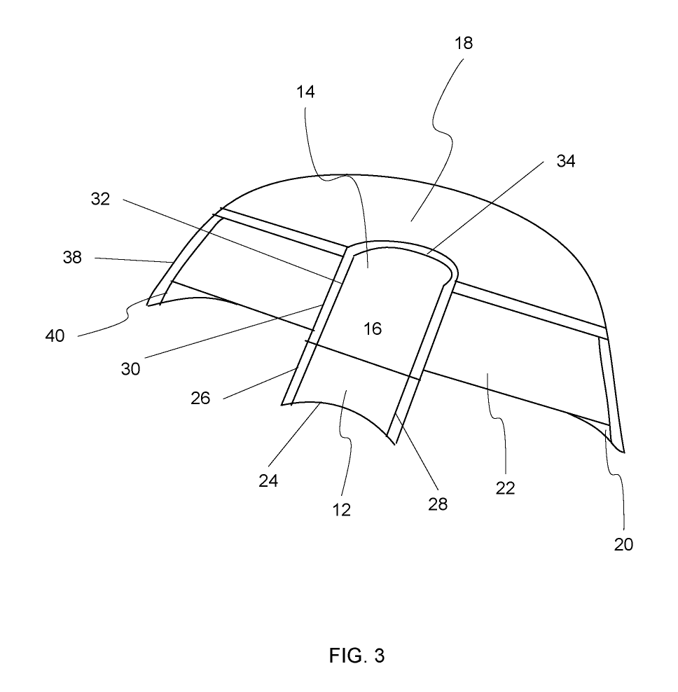

FIGS. 3 and 4 illustrate a sectional view of a unifit sleeve 10 for an earpiece. FIG. 3 illustrates a sectional view from a front overhead perspective. FIG. 4 illustrates a sectional view of the unifit sleeve 10 fitted onto a wireless earpiece 36 and inserted into an external auditory canal 46. The unifit sleeve 10 includes a base portion 12, a stem portion 14, a conduit 16, an outer flange 18, a circumferential cavity 20, and a self-conforming member 22. The base portion 12 includes an inner end 24, an outer circumference 26, and an inner circumference 28. The stem portion 14 includes an outer circumference 30 and an inner circumference 32 and extends from the base portion 12 and terminates at an outer end 34. The conduit 16 extends through the base portion 12 and the stem portion 14 from the inner end 24 of the base portion 12 to the outer end 34 of the stem portion 14 and is circumscribed by the inner circumference 28 of the base portion 12 and the inner circumference 32 of the stem portion 14 to operably secure to a wearable device 36. The outer flange 18 includes an exterior surface 38 and an interior surface 40, is connected to the outer end 34 of the stem portion 14, and extends outwardly and downwardly toward the base portion 12. The interior surface 40 of the outer flange 18 and the outer circumference 30 of the stem portion 14 circumscribe the circumferential cavity 20. The self-conforming member 22 is disposed within the circumferential cavity 20 and affixed at the outer end 34 of the stem portion 14.

The base portion 12 may be composed of one or more elastic and flexible materials such as silicon, a silicon composite or one or more polymers (such as plastic) having substantial tensile strength to resist tearing. The base portion 12 may be attached to a wearable device by stretching the inner end 24 such that the inner circumference 28 has a larger circumference than the diameter of the component in which the base portion 12 is to be affixed, such as a tip or an ear mold. The inner end 24 is then slipped onto the component, in which the compressive forces of the base portion 12 may hold it in place.

The stem portion 14, like the base portion 12, may be composed of one or more elastic and flexible materials such as silicon, a silicon composite or one or more polymers (such as plastic) having substantial tensile strength to resist tearing. The stem portion 14 may also be attached to a wearable device in much the same way as the base portion 12, though the stem portion 14 may be attached by slipping the stem portion 14 onto the wearable device component after the base portion 12 has been affixed in some manner to the wearable device.

The conduit 16 may extend through the base portion 12 and the stem portion 14 from the inner end 24 of the base portion 12 to the outer end 34 of the stem portion 14 and may enclose a portion or the entirety of the component of the wearable device used to operably secure the unifit sleeve 10 to the wearable device. The conduit 16 may be cylindrically shaped, polygonally shaped, or shaped as another closed figure, and the dimensions of the conduit 16 need not be uniform. For example, the conduit 16 may be conically shaped, with the cross-sectional area of the conduit 16 expanding toward the outer end 34 of the stem portion 14. In addition, the axis of the shape circumscribed by the conduit 16 may not be straight or consistent throughout. For example, the conduit 16 may be circumscribed by a base portion 12 and a stem portion 14 having differing cross-sectional areas in which the axes of the cross-sectional areas are asynchronous.

The outer flange 18, like the base portion 12 and the stem portion 14, may be composed of one or more elastic and flexible materials such as silicon, a silicon composite or one or more polymers (such as plastic) having substantial tensile strength to resist tearing. The outer flange 18 may extend outwardly and downwardly from the outer end 34 of the stem portion 14 and may have substantial flexibility in order to be placed within an external auditory canal. In some embodiments one or more hollow conduits may also extend longitudinally through the outer flange 18 providing relief from occlusive effects as well as improving audio transparency.

The circumferential cavity 20 may be disposed between the interior surface 40 of the outer flange 18 and the outer circumference 30 of the stem portion 14. In addition, in some embodiments, a hydrophobic constituent 42 may be affixed to the interior surface 40 of the outer flange 18 and the outer circumference 30 of the stem portion 14 and may completely enclose the circumferential cavity 20 to create a second circumferential cavity. The self-conforming member 22 may partially or completely fill the second circumferential cavity upon insertion of the unifit sleeve 10 affixed to a wireless earpiece into an external auditory canal.

The self-conforming member 22 may be disposed within the circumferential cavity 20 between the interior surface 40 of the outer flange 18 and the outer circumference 30 of the stem portion 14 and may be affixed at the outer circumference 30 of the stem portion 14. In some embodiments the self-conforming member 22 may also be affixed at other locations on the stem portion 14 or may be affixed to the interior surface 40 of the outer flange 18. The self-conforming member 22 may be composed of or filled with one or more elastic materials or material combinations capable of substantially returning to its original shape after a deformation, such as foams, memory foams, polyesters, rubber, microbeads, nanobeads, polystyrene beads, one or more gases suspended in a liquid solution, or one or more shape-memory alloys or polymers, and the foregoing list is non-exclusive. In some embodiments, the self-conforming member 22 may also have hydrophobic or other physical or chemical properties providing resistance to ingressing water and moisture. The self-conforming member 22 may bias the outer flange 18 away from the outer circumference 30 of the stem portion 14 such that the perimeter of the outer flange 18 is larger than the perimeter of an outer opening of the external auditory canal 46 such that the entire outer edge of the outer flange 18 makes contact with the inner surface of the external auditory canal 46 when the unifit sleeve 10 is inserted into the external auditory canal 46. By biasing the outer flange 18 away from the stem portion 14 while having the capability to undergo a deformation in response to being inserted into an external auditory canal of a user's ear, the self-conforming member 22 allows the unifit sleeve 10 to provide a snug fit within the external auditory canal of a user's ear irrespective of the shape of the user's external auditory canal. The self-conforming member 22 should bias the outer flange 18 such that the circumference of the circumferential cavity 20 is larger than the circumference or perimeter of the outer opening of the user's external auditory canal, as the ears of certain users may not allow the tip of a wireless earpiece or other wearable ear device to completely fit within the external auditory canal. When used with a wireless earpiece or other wearable ear device and inserted into the ear the unifit sleeve 10 not only seals the outer flange 18 against the external auditory canal but it also helps retain the wireless earpiece or other wearable ear device from becoming dislodged during use.

FIG. 5 illustrates a sectional view of a second embodiment of a unifit sleeve 10 fitted to a wireless earpiece. The unifit sleeve 10 further comprises a hydrophobic constituent 42 and a second circumferential cavity 44. The hydrophobic constituent 42 may be attached to the interior surface 40 of the outer flange 18 and the outer circumference 26 of the stem portion 14 and may be composed of any material that is both flexible and substantially non-permeable to water and moisture. Such materials may include plastics, rubber, and certain types of polymers. In some embodiments the hydrophobic constituent 42 may also be attached to the bottom of the self-conforming member 22 for additional support. The second circumferential cavity 44 may be disposed between the self-conforming member 22 and the hydrophobic constituent 42 and the space between the self-conforming member 22 and the hydrophobic constituent 44 may allow the self-conforming member 22 to “fill” the second circumferential cavity in response to the compression of the self-conforming member 22 when inserted into an external auditory canal. The second circumferential cavity 44 may be partially or completely filled in response to the compression of the self-conforming member 22, and the compression of the self-conforming member 22 may push the hydrophobic constituent 42 outward toward the base portion 12.

What is claimed is:

1. A unifit sleeve comprising:
a base portion having an inner end, an outer circumference and an inner circumference;
a stem portion extending from the base portion and terminating at an outer end, the stem portion having an outer circumference and an inner circumference;
a conduit extending through the base portion and the stem portion from the inner end of the base portion to the outer end of the stem portion, wherein the inner circumference of the base portion and the inner circumference of the stem portion circumscribe the conduit, wherein the conduit is further configured for operably securing to a wearable device;
an outer flange connected to the outer end of the stem portion, the outer flange having an exterior surface and an interior surface wherein the outer flange extends outwardly and downwardly toward the base portion;
a circumferential cavity between the interior surface of the outer flange and the outer circumference of the stem portion; and
a self-conforming member disposed within the circumferential cavity, the self-conforming member affixed within the circumferential cavity at the outer end of the stem portion;
wherein the self-conforming member biases the outer flange outward away from the outer circumference of the stem portion.

2. The unifit sleeve of claim 1 wherein the self-conforming member is composed of a memory foam.

3. The unifit sleeve of claim 1 wherein the self-conforming member further comprises a hydrophobic constituent affixed between the outer circumference of the stem portion and the interior surface of the outer flange at a bottom end of the self-conforming member.

4. The unifit sleeve of claim 1 further comprising a hydrophobic constituent affixed to the interior surface of the outer flange and the outer circumference of the stem portion, wherein the hydrophobic constituent encloses the circumferential cavity with the self-conforming member.

5. The unifit sleeve of claim 4 wherein a second circumferential cavity is disposed between the self-conforming member and the hydrophobic constituent, wherein the second circumferential cavity is filled in response to a compression of the self-conforming member.

6. The unifit sleeve of claim 1 wherein at least one second conduit configured to connect an external auditory canal to an outside of an ear is disposed longitudinally within the outer flange.

7. A self-conforming earpiece sleeve comprising:
a base portion having an inner end, an outer circumference and an inner circumference;
a stem portion extending from the base portion and terminating at an outer end, the stem portion having an outer circumference and an inner circumference;
a conduit extending through the base portion and the stem portion from the inner end of the base portion to the outer end of the stem portion, wherein the inner circumference of the base portion and the inner circumference of the stem portion circumscribe the conduit having a connection interface operably configured for securing to a tip of a wireless earpiece;
an outer flange connected to the outer end of the stem portion, the outer flange having an exterior surface and an interior surface wherein the outer flange extends outwardly and downwardly from the outer end toward the base portion;
a circumferential cavity between the interior surface of the outer flange and the outer circumference of the stem portion;
a self-conforming member disposed within the circumferential cavity, the self-conforming member affixed within the circumferential cavity adjacent the outer end of the stem portion; and
a hydrophobic constituent disposed in combination with the self-conforming member at the interior surface of the outer flange and the outer circumference of the stem portion, wherein the hydrophobic constituent substantially occludes moisture from interacting with the self-conforming member;
wherein the self-conforming member biases the outer flange outward away from the outer circumference of the stem portion.

8. The self-conforming earpiece sleeve of claim 7 wherein the self-conforming member is a memory foam.

9. The self-conforming earpiece sleeve of claim 7 wherein a second circumferential cavity is disposed between the self-conforming member and the hydrophobic constituent, wherein the second circumferential cavity is filled in response to a compression of the self-conforming member.

10. The self-conforming earpiece sleeve of claim 8 wherein the self-conforming member is configured when inserted into an external auditory canal of an ear to bias the outer flange outward against the external auditory canal.

11. The self-conforming earpiece sleeve of claim 10 wherein the self-conforming member biases the outer flange against the external auditory canal wherein points of contact between the outer flange and the external auditory canal comprise a 360° circumference.

12. The self-conforming earpiece sleeve of claim 7 wherein at least one second conduit configured to connect an external auditory canal to an outside of an ear is disposed longitudinally within the outer flange.

13. A unfit sleeve for a wireless earpiece comprising:
a base portion having an inner end, an outer circumference and an inner circumference;
a stem portion extending from the base portion and terminating at an outer end, the stem portion having an outer circumference and an inner circumference;
a conduit extending through the base portion and the stem portion from the inner end of the base portion to the outer end of the stem portion, wherein the inner circumference of the base portion and the inner circumference of the stem portion circumscribe the conduit configured for operably securing to the wireless earpiece;
an outer flange connected to the outer end of the stem portion, the outer flange having an exterior surface and an interior surface wherein the outer flange extends outwardly and downwardly toward the base portion;
a circumferential cavity between the interior surface of the outer flange and the outer circumference of the stem portion; and
a self-conforming member disposed within the circumferential cavity, the self-conforming member affixed within the circumferential cavity at the outer end of the stem portion;
wherein the self-conforming member biases the outer flange outward away from the outer circumference of the stem portion.
wherein the unifit sleeve is operably secured to a tip of the wireless earpiece; and
wherein the tip of the wireless earpiece with the unifit sleeve operably secured to the tip is configured to be operably placed into an external auditory canal of an ear.

14. The unifit sleeve of claim 13 wherein the self-conforming member is a memory foam.

15. The unifit sleeve of claim 13 wherein the self-conforming member comprises an air pillow.

16. The unifit sleeve of claim 13 wherein a hydrophobic constituent is affixed to the interior surface of the outer flange and the outer circumference of the stem portion, wherein the hydrophobic constituent encloses the circumferential cavity with the self-conforming member.

17. The unifit sleeve of claim 16 wherein a second circumferential cavity is disposed between the self-conforming member and the hydrophobic constituent, wherein the second circumferential cavity is filled in response to a compression of the self-conforming member.

18. The unifit sleeve of claim 13 wherein the self-conforming member is configured when inserted into an external auditory canal of an ear to bias the outer flange outward against the external auditory canal.

19. The unifit sleeve of claim 13 wherein the self-conforming member biases the outer flange against the external auditory canal wherein points of contact between the outer flange and the external auditory canal comprise a 360° circumference.

20. The unifit sleeve of claim 13 wherein at least one second conduit configured to connect an external auditory canal to an outside of an ear is disposed longitudinally within the outer flange.
